(19) United States
(12) Patent Application Publication
(10) Pub. No.: US 2026/0277609 A1
(43) Pub. Date: Sep. 17, 2026

(54) METHOD AND APPARATUS FOR PARALLEL POINTER OPERATIONS

(71) Applicant: ELECTRONICS AND TELECOMMUNICATIONS RESEARCH INSTITUTE, Daejeon (KR)

(72) Inventor: Yong Ho LEE, Sejong-si (KR)

(21) Appl. No.: 19/564,628

(22) Filed: Mar. 12, 2026

(30) Foreign Application Priority Data
Mar. 13, 2025 (KR) 10-2025-0032543
Mar. 5, 2026 (KR) 10-2026-0039637

(51) Int. Cl. G06F 9/30

(52) U.S. Cl. CPC G06F 9/30109; G06F 9/30036; G06F 9/30065

(57) ABSTRACT

A method and apparatus for parallel pointer operations are disclosed. According to one aspect of the present disclosure, there is provided a method performed by one or more computers for performing a loop operation including pointer operations on a plurality of pointers, the method comprising: a pointer vectorization process of vectorizing the plurality of pointers by storing an address value pointed to by each of the plurality of pointers as an individual element of a vector register of a processor to generate a vector variable, wherein each element of the vector variable represents a memory address of an individual pointer; and a pointer vector operation process of updating addresses of the plurality of pointers stored in the vector register in parallel through a vector operation using a preset vector offset variable during execution of a loop body.

### CROSS-REFERENCE TO RELATED APPLICATIONS

The present application claims priority to Korean Patent Application No. 10-2025-0032543, filed on Mar. 13, 2025, and Korean Patent Application No. 10-2026-0039637, filed on Mar. 5, 2026, the disclosures of which are incorporated by reference herein in their entireties.

### TECHNICAL FIELD

The present disclosure relates to a method and apparatus for parallel pointer operations. More specifically, the present disclosure relates to a method and apparatus for parallel pointer operations. More particularly, the present disclosure relates to a method and apparatus for managing a plurality of pointer address values in a vector form using vector registers of a CPU and performing pointer operations within a loop in parallel through SIMD (Single Instruction Multiple Data) vector operations.

### BACKGROUND

The statements in this section merely provide background information related to the present disclosure and do not necessarily constitute prior art.

It is very common to use a plurality of pointers when performing loop operations in a program. In loops that handle arrays, linked lists, or other data structures, a plurality of pointers each point to different data regions, and the pointers are updated during each loop iteration to access data.

In the conventional individual pointer approach, each pointer operates independently and accesses memory individually during operations. This approach has a high likelihood of non-contiguous memory accesses, which may reduce the probability of CPU cache hits, thereby causing performance degradation such as memory access latency.

Furthermore, individual pointer operations have a structural limitation in that they cannot sufficiently exploit instruction-level parallelism of the CPU. Although modern processors are designed to process multiple operations in parallel through instruction pipelines, in the individual pointer approach, each operation is executed sequentially, which increases the likelihood of pipeline stalls and branch prediction failures. This results in degraded CPU computational performance and increased unnecessary instruction execution overhead.

In particular, recent high-performance processors provide the capability to simultaneously process a plurality of data using SIMD (Single Instruction Multiple Data) operation units, but the conventional individual pointer approach makes it difficult to utilize such vector operations. Since each pointer operation is performed independently, the advantages of SIMD, which processes multiple data with a single instruction, cannot be maximized, leading to performance degradation.

Additionally, individual pointer operations that repeatedly occur within a loop require address computation and memory access each time an operation is performed, resulting in increased instruction overhead. This not only reduces operational speed but also leads to unnecessary power consumption. Particularly in high-speed computing environments such as artificial intelligence, machine learning, data analysis, graphics processing, and high-performance computing (HPC), such inefficiency may become a bottleneck for overall system performance when processing large-scale data using a plurality of pointers.

### SUMMARY

A primary object of the present disclosure is to provide a method and apparatus capable of reducing the number of instruction executions and execution cycles of pointer operations within a loop by performing a plurality of pointer operations in parallel using a vector operation unit of a CPU.

A primary object of the present disclosure is to provide a method and apparatus capable of optimizing memory access patterns and improving cache hit probability by storing a plurality of pointer address values in a vector register and updating them in a single vector operation.

A primary object of the present disclosure is to provide a method and apparatus capable of improving computational performance in large-scale data processing environments such as artificial intelligence, machine learning, and high-performance computing through vectorization of pointer operations in processors supporting the SIMD architecture.

The problems to be solved by the present invention are not limited to the above-mentioned problems, and other problems not mentioned herein will be clearly understood by those of ordinary skill in the art from the following description.

According to one aspect of the present disclosure, there is provided a method performed by one or more computers for performing a loop operation including pointer operations on a plurality of pointers, the method comprising: a pointer vectorization process of vectorizing the plurality of pointers by storing an address value pointed to by each of the plurality of pointers as an individual element of a vector register of a processor to generate a vector variable, wherein each element of the vector variable represents a memory address of an individual pointer; and a pointer vector operation process of updating addresses of the plurality of pointers stored in the vector register in parallel through a vector operation using a preset vector offset variable during execution of a loop body.

According to another aspect of the present disclosure, there is provided an apparatus for performing a loop operation including pointer operations on a plurality of pointers, the apparatus comprising: a memory storing instructions; and a processor including a vector register, wherein the processor is configured to, by executing the instructions, perform pointer vectorization of vectorizing the plurality of pointers by storing an address value pointed to by each of the plurality of pointers as an individual element of the vector register to generate a vector variable, wherein each element of the vector variable represents a memory address of an individual pointer, and perform a pointer vector operation of updating addresses of the plurality of pointers stored in the vector register in parallel through a vector operation using a preset vector offset variable during execution of a loop body.

According to an embodiment of the present disclosure, by replacing a plurality of pointer operations with vector operations, the number of instruction executions for pointer operations within a loop can be reduced and execution cycles can be saved.

According to an embodiment of the present disclosure, by actively utilizing the SIMD vector operation unit of a CPU to parallelize operations and optimize memory accesses, faster and more efficient operations can be achieved in artificial intelligence, machine learning, and high-performance data processing environments.

According to an embodiment of the present disclosure, by optimizing memory access patterns through vectorization of pointer operations, cache hit probability can be increased and power consumption can be reduced.

According to an embodiment of the present disclosure, since the performance improvement effect by vectorization increases as the number of pointers increases, computational performance can be improved in environments requiring large-scale parallel operations.

The effects of the present disclosure are not limited to the above-mentioned effects, and other effects not mentioned herein will be clearly understood by those of ordinary skill in the art from the following description.

### BRIEF DESCRIPTION OF THE DRAWINGS

FIG. 1 is a block diagram schematically illustrating a pointer operation apparatus according to an embodiment of the present disclosure.

FIG. 2 is a flowchart illustrating a conventional loop operation procedure using a plurality of pointers.

FIG. 3 is a flowchart illustrating a pointer vectorization-based loop operation procedure according to an embodiment of the present disclosure.

FIG. 4 is a flowchart illustrating a pointer vectorization procedure according to an embodiment of the present disclosure.

FIG. 5 is a flowchart illustrating a detailed procedure of a pointer vector operation process according to an embodiment of the present disclosure.

FIG. 6 is a diagram illustrating a memory allocation and access structure in a conventional individual pointer approach.

FIG. 7 is a diagram illustrating a memory allocation and access structure utilizing a vector variable-based pointer-to-vector element mapping according to an embodiment of the present disclosure.

FIG. 8 is a diagram illustrating a CPU execution flow in which pointer setup and pointer operations within a loop are performed in a conventional individual pointer approach.

FIG. 9 is a diagram illustrating a CPU execution flow in which pointer setup, vectorization, and pointer vector operations within a loop are performed in a pointer vectorization approach according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure and is not intended to represent the only embodiments in which the present disclosure may be practiced.

The definitions of terms used in the present disclosure are as follows. A “pointer” refers to a variable that points to a specific location (address) in memory. A “vector register” refers to a register located inside a processor that can simultaneously store a plurality of data elements. “SIMD (Single Instruction Multiple Data)” refers to a processor architecture that simultaneously processes a plurality of data with a single instruction. A “vector element” refers to an individual data unit stored in a vector register. A “vector operation unit” refers to an operation unit inside a processor that performs parallel operations on a plurality of data elements stored in a vector register. An “offset” refers to a relative position change amount from a base address. A “loop” refers to a code block that is repeatedly executed while a specific condition is satisfied.

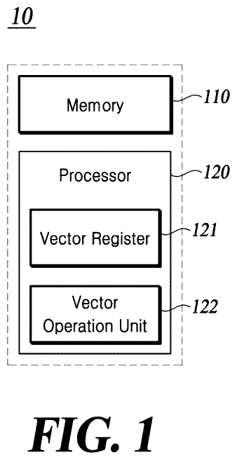

FIG. 1 is a block diagram schematically illustrating a pointer operation apparatus 10 according to an embodiment of the present disclosure.

The pointer operation apparatus 10 includes a memory 110 and a processor 120. The pointer operation apparatus 10 may be implemented in the form of a desktop computer, a server, a laptop computer, a smartphone, a vehicle electronic device, an embedded device, or the like. Not all blocks shown in FIG. 1 are essential components, and in other embodiments, some blocks included in the pointer operation apparatus 10 may be added, changed, or deleted. Meanwhile, the components shown in FIG. 1 represent functionally distinguishable elements, and at least one component may be implemented in a form integrated with each other in an actual physical environment.

The memory 110 stores data and commands necessary for the operation of the pointer operation apparatus 10. The memory 110 may store a program that causes the processor 120 to perform methods or operations according to various embodiments of the present disclosure. The memory 110 may include at least one of volatile memory (SRAM, DRAM, etc.) and non-volatile memory (flash memory, etc.).

The processor 120 controls the overall operation of the pointer operation apparatus 10. The processor 120 may be implemented as one or more processors. The processor 120 may execute instructions stored in the memory 110.

The processor 120 may include a vector register 121 and a vector operation unit 122.

The vector register 121 stores an address value pointed to by each of a plurality of pointers as an individual element to generate a vector variable. The vector register 121 has a predetermined register size, and the number of pointers that can be processed with a single instruction is determined according to the register size. The vector register 121 may be a register supporting the SIMD architecture of the processor 120. For example, in the case of a 256-bit vector register, up to four 64-bit address values can be stored simultaneously.

The vector operation unit 122 updates addresses of a plurality of pointers stored in the vector register 121 in parallel through a vector operation using a preset vector offset variable during execution of a loop body. The vector operation unit 122 may include a vector addition operator that performs addition operations in parallel on corresponding elements between a plurality of address values stored in the vector register 121 and a plurality of offset values stored in the vector offset variable.

The processor 120 may be configured to, by executing instructions stored in the memory 110, in performing a loop operation, set up a plurality of pointers, perform pointer vectorization to vectorize the plurality of pointers, initialize a loop variable, check a loop condition, execute a loop body when the loop condition is satisfied, perform pointer operations on the plurality of pointers in parallel by performing a vector operation on a pointer vector generated in the pointer vectorization after execution of the loop body, and update the loop variable.

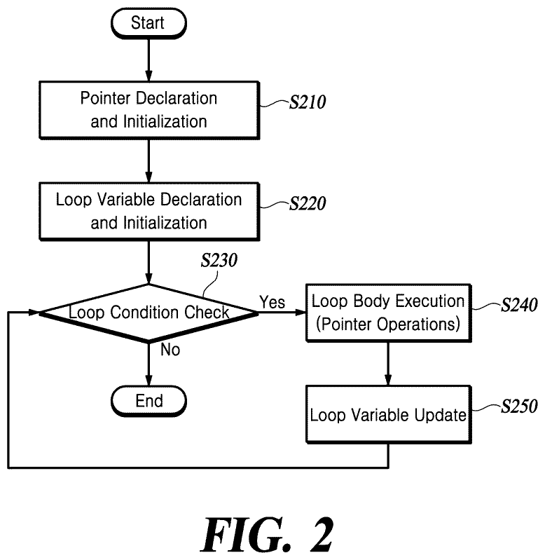

FIG. 2 is a flowchart illustrating a conventional loop operation procedure using a plurality of pointers. In order to more clearly understand the advantages of the pointer vectorization-based loop operation method proposed in the present disclosure, the conventional loop operation procedure and its limitations will be examined with reference to FIG. 2.

When a program performs a loop operation using a plurality of pointers, the procedure generally proceeds as follows.

First, a plurality of pointers to be used in the loop are declared and initialized (S210). In this process, each pointer is set to point to a specific memory address, thereby handling arrays, linked lists, or other data structures.

Next, a loop variable is initialized for loop execution (S220), and a loop condition check is performed (S230). In step S230, it is checked whether to continue the loop, and the loop is terminated if a specific condition is not satisfied. Conversely, if the loop condition is satisfied, the loop body is executed.

When the loop body is executed, operations on the plurality of pointers are performed (S240). Each pointer moves to a new position or performs operations such as reading or writing specific data according to a predefined manner. In the conventional approach, since each pointer operation is performed individually, the number of instruction executions increases in proportion to the number of pointers as more pointers are used.

When the loop body execution is completed, the loop variable value is updated (S250), and the loop condition check is performed again (S230). If the loop condition is still satisfied, the loop body is executed again to perform operations on the plurality of pointers (S240), and if the loop condition is not met, the loop terminates.

As described above, the conventional loop operation using a plurality of pointers repeats a series of steps consisting of “pointer setup (S210)→loop variable initialization (S220)→loop condition check (S230)→loop body execution and multiple pointer operations (S240)→loop variable update (S250)→loop condition re-check (S230).” In the conventional approach, since operations on each pointer are performed individually in step S240, instruction overhead increases linearly as the number of pointers increases.

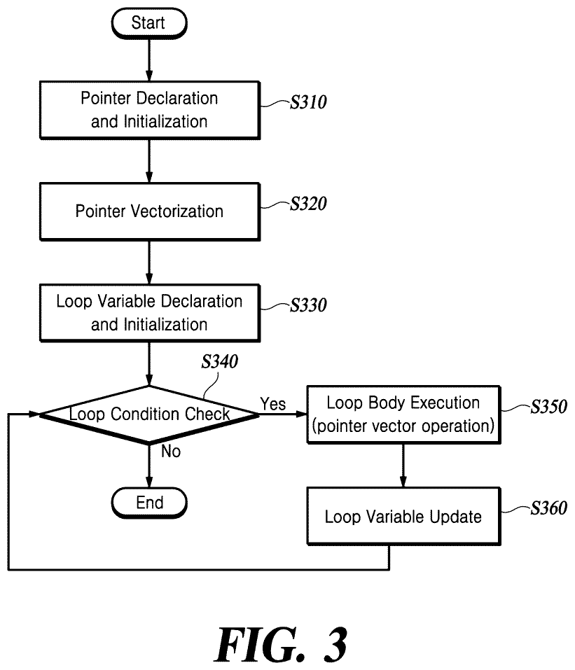

FIG. 3 is a flowchart illustrating a pointer vectorization-based loop operation procedure according to an embodiment of the present disclosure.

The present disclosure introduces the concept of pointer vectorization to improve the conventional loop operation procedure. To this end, in the conventional approach, (i) a process of vectorizing a plurality of pointers is added between the pointer setup (S210) and loop variable initialization (S220) of FIG. 2, and (ii) the plurality of pointer operations that were individually performed in the loop body are replaced with vector operations.

First, the pointer operation apparatus 10 declares and initializes a pointer for each of a plurality of arrays (S310).

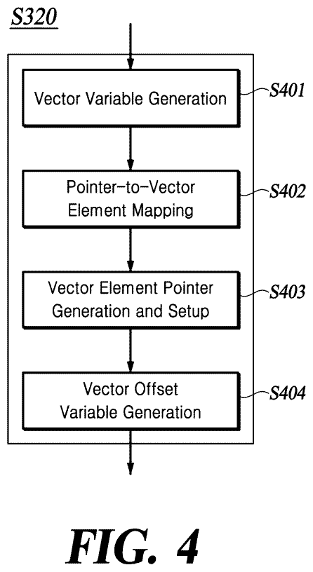

Next, the pointer operation apparatus 10 performs pointer vectorization to vectorize a plurality of pointers (S320). In the pointer vectorization process, the pointer operation apparatus 10 integrates individual pointers into a single vector structure. Pointer vectorization is a process of transforming a plurality of pointers so that they can be managed as a single vector unit utilizing CPU registers or SIMD instructions. The specific procedure of the pointer vectorization process will be described later with reference to FIG. 4.

The pointer operation apparatus 10 initializes a loop variable (S330) and performs a loop condition check (S340). If the loop condition is not satisfied, the loop terminates, and if satisfied, the loop body is executed.

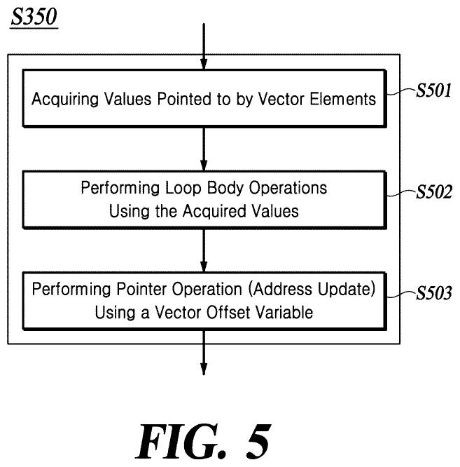

When the loop body is executed, the pointer operation apparatus 10 performs a pointer vector operation (S350). In the conventional approach, operations were performed individually on each pointer within the loop, but in the present disclosure, by replacing them with a pointer vector operation, a plurality of pointers can be processed with a single vector operation instruction. This enables a reduction in the number of repeatedly performed pointer operations and optimization of instruction execution. The specific detailed procedure of the pointer vector operation process (S350) will be described later with reference to FIG. 5.

The pointer operation apparatus 10 updates the loop variable (S360) and performs the loop condition check (S340) again. If the loop condition is satisfied, the process returns to step S350, and if not satisfied, the loop terminates.

The present approach significantly improves operational efficiency compared to the conventional approach. In the conventional approach, since pointer operations are performed sequentially, the processing speed of the CPU may be limited by memory access speed. By utilizing vectorized pointer operations, since a plurality of pointers are processed simultaneously, the operational speed increases. Furthermore, vectorization of pointer operations can optimize cache utilization and configure memory access patterns more efficiently.

FIG. 4 is a flowchart illustrating a pointer vectorization procedure according to an embodiment of the present disclosure. The pointer vectorization process corresponds to step S320 of FIG. 3 and consists of four main stages (vector variable generation, pointer-to-vector element conversion, vector element pointer generation and setup, and vector offset variable generation). Through this, individual pointer-based operations are converted to vector operations, enabling parallel operations.

In the vector variable generation stage, the processor 120 generates a vector variable by utilizing a CPU register to manage a plurality of pointers as a single vector unit (S401). In the conventional approach, pointer variables were declared individually, but in the present disclosure, the processor 120 converts them into a vector structure and stores a plurality of pointer information in a single vector variable. By utilizing the SIMD registers of the CPU or dedicated registers supporting vector operations, a plurality of pointers can be efficiently managed and data access speed can be improved.

In the pointer-to-vector element conversion stage, the processor 120 converts and stores the address value that each pointer pointed to as an element of the vector variable (S402). That is, each element of the vector variable takes a form containing a specific memory address value.

In the vector element pointer generation and setup stage, the processor 120 interprets the value stored in each element of the previously converted vector variable as an address and generates individual pointers pointing to that value (S403). That is, the processor 120 interprets the values stored in the vector variable elements as addresses and newly generates individual pointers that directly reference those addresses. This is not a method of referencing the vector variable elements themselves, but a method of regarding the values held by the elements as valid memory addresses and setting pointers pointing to them. Through this, individual pointer access becomes possible while performing vector operations, and efficient vector operations are achieved while replacing conventional individual pointer operations.

In the vector offset variable generation stage, the processor 120 sets a vector offset variable for managing the relative memory position (offset) of individual pointers during vector operation execution (S404). This offset variable defines the relative change in memory address referenced by each pointer as vector operations are repeated, thereby enabling pointer movement according to a consistent rule. The vector offset variable may include a vector value containing different offsets for each vector element pointer, and since optimized offset management is possible according to the characteristics of the data structure, performance improvement in loop-based operations can be expected.

This series of processes provides the effect of reducing the number of CPU instruction executions and optimizing memory access patterns by replacing conventional individual pointer operations with vector operations. As a result, the present disclosure contributes to improving operational speed by processing a plurality of pointer operations in parallel in vector units and implementing a more optimized data access structure through vector operations utilizing CPU registers.

FIG. 5 is a flowchart illustrating a detailed procedure of the pointer vector operation process (S350) according to an embodiment of the present disclosure. The pointer vector operation process (S350) corresponds to the loop body execution stage of FIG. 3 and consists of three main stages.

First, the processor 120 acquires data values from memory locations pointed to by the address values stored in each element of the vector register 121 (S501). That is, by referencing the plurality of pointer addresses stored in the vector register 121, data at the memory locations pointed to by each address is read in parallel through a vector load instruction.

Next, the processor 120 performs loop body operations using the values acquired in step S501 (S502). In this stage, operations corresponding to actual program logic (e.g., data processing, accumulation operations, conditional branching, etc.) are executed.

Finally, the processor 120 performs pointer operations (address update) using the vector offset variable (S503). The vector operation unit 122 performs addition operations in parallel on corresponding elements between the plurality of address values stored in the vector register 121 and the plurality of offset values stored in the vector offset variable, thereby simultaneously updating the addresses of all pointers with a single vector instruction. This enables access to data at new memory locations through the updated addresses in the next loop iteration.

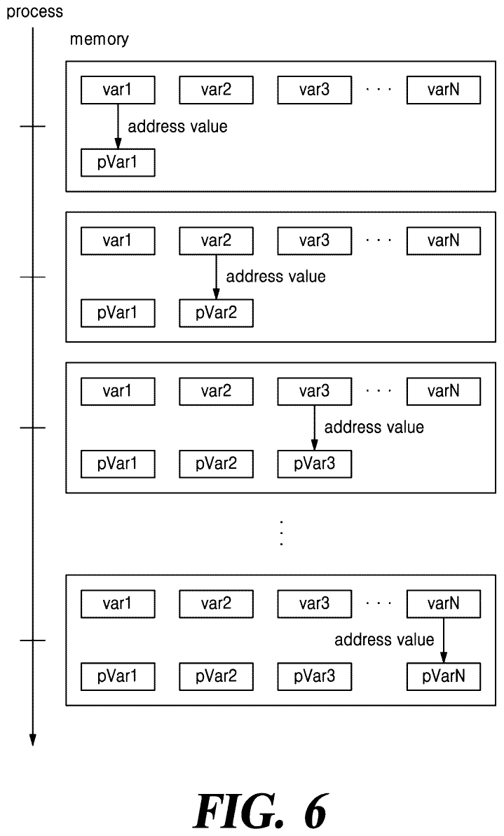

FIG. 6 is a diagram illustrating a memory allocation and access structure in a conventional individual pointer approach.

Referring to FIG. 6, a process of sequentially assigning pointer variables (pVar1, pVar2, pVar3, . . . , pVarN) one by one to a plurality of variables (var1, var2, var3, . . . , varN) arranged in a memory (110) region is illustrated. The process axis shown on the left side of FIG. 6 represents the flow of time, and shows that one variable address is individually assigned to one pointer variable at each stage. That is, in the first stage, the address value of var1 is assigned to pVar1, and in the second stage, the address value of var2 is assigned to pVar2, such that N individual address assignment operations for N variables are sequentially performed. In this approach, as the number of pointers increases, the number of instruction executions required for allocation and operations increases linearly, and even if the CPU supports vector operations, individual pointer operations are processed in a scalar manner, so the benefits of parallelization cannot be utilized.

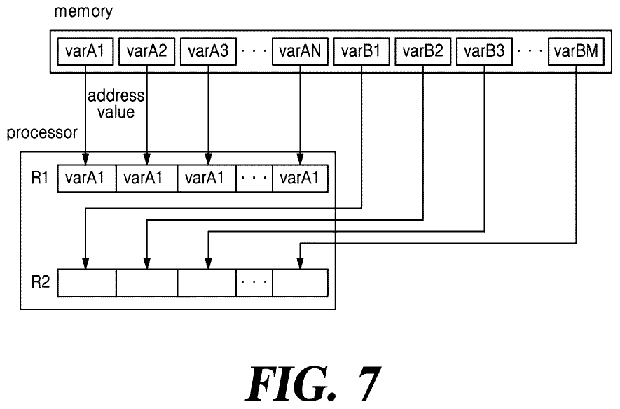

FIG. 7 is a diagram illustrating a memory allocation and access structure utilizing a vector variable-based pointer-to-vector element mapping according to an embodiment of the present disclosure.

Referring to FIG. 7, a plurality of different arrays (varA1 through varAN and varB1 through varBM) are arranged in a memory (110) region, and a structure for storing and managing variable address values of each array in separate vector registers using a plurality of vector registers (R1, R2) inside a processor (120) is illustrated. Address values for N arrays (varA1 through varAN) are stored as individual elements (elem1, elem2, elem3, . . . , elemN) in vector register R1, and address values for M arrays (varB1 through varBM) are stored in vector register R2. In the present disclosure, by applying a pointer-to-vector element mapping using CPU vector registers as described above, address values of each variable are not stored in individual pointer variables but are converted into elements of vector registers and stored collectively and processed in vector units. This vectorization approach can directly utilize the SIMD operations of the CPU, enabling simultaneous loading or computing of a plurality of address values, and enabling simultaneous data access and operations on multiple arrays.

As a result, the approach of the present disclosure (FIG. 7) provides the effect of optimizing memory access patterns and maximizing parallel processing performance by actively utilizing vector operations of the CPU, compared to the conventional individual pointer approach (FIG. 6).

For a single line of code in a program to be executed, five stages must be traversed: \textcircled{1}Instruction Fetch, \textcircled{2} Instruction Decode, \textcircled{3} Operand Fetch, \textcircled{4} Instruction Execution, and \textcircled{5} Write Back.

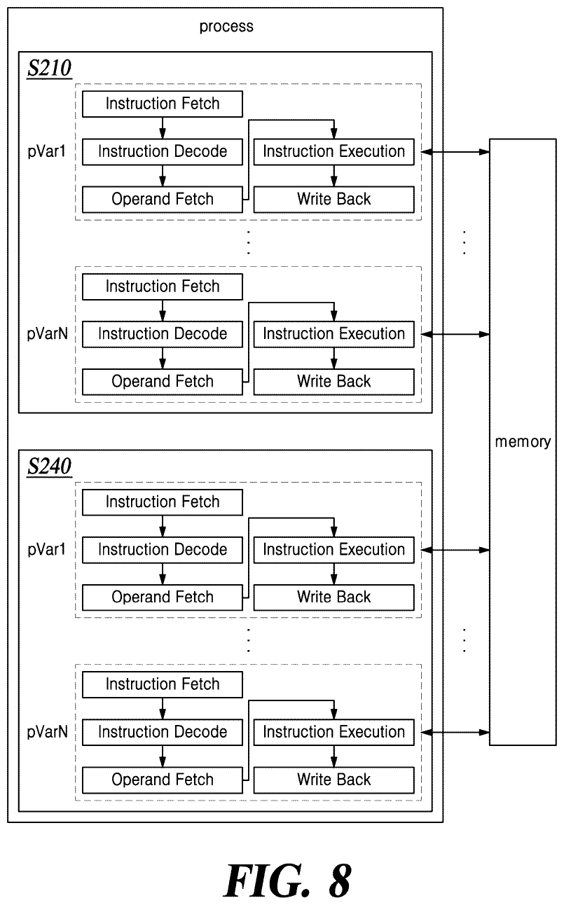

FIG. 8 is a diagram illustrating a CPU execution flow in which pointer setup and pointer operations within a loop are performed in a conventional individual pointer approach.

Referring to FIG. 8, a structure in which the pointer declaration and initialization process (S210) and the loop body execution process (S240) are performed while interacting with memory inside the processor is illustrated.

In the pointer declaration and initialization process (S210), the processor individually performs a 5-stage pipeline (\textcircled{1} Instruction Fetch→\textcircled{2} Instruction Decode→\textcircled{3} Operand Fetch→\textcircled{4} Instruction Execution→\textcircled{5} Write Back) for each pointer variable (pVar1 through pVarN). That is, N independent pipeline executions are required to initialize N pointers.

In the loop body execution process (S240), similarly, the same 5-stage pipeline is individually performed for each pointer variable (pVar1, pVar2, . . . ). As a result, the number of instruction executions increases in proportion to the number of pointers, and since memory is accessed individually for each pointer operation, the probability of cache misses and memory bandwidth consumption increase. Additionally, as a plurality of pointer variables are individually operated, CPU instruction scheduling and pipeline parallel processing efficiency are degraded.

The present disclosure manages a plurality of pointers in a single vector register using CPU registers to solve the problems of the conventional approach.

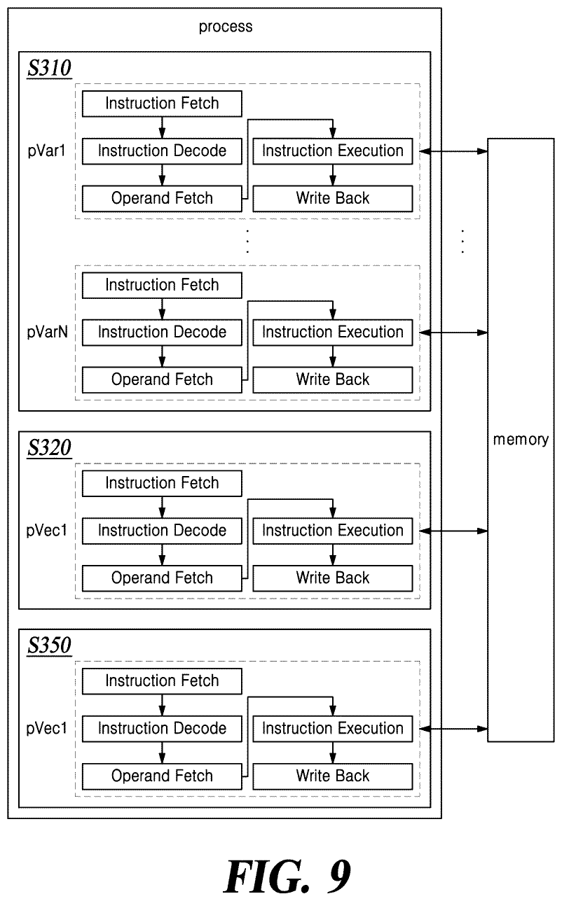

FIG. 9 is a diagram illustrating a CPU execution flow in which pointer setup, vectorization, and pointer vector operations within a loop are performed in a pointer vectorization approach according to an embodiment of the present disclosure.

Referring to FIG. 9, a structure in which the pointer declaration and initialization process (S310), the pointer vectorization process (S320), and the loop body execution process (S350) are performed while interacting with memory 110 inside the processor 120 is illustrated.

In the pointer declaration and initialization process (S310), as in the conventional approach, a 5-stage pipeline is individually performed for each pointer variable (pVar1 through pVarN).

However, in the pointer vectorization process (S320), the operation of integrating a plurality of pointers into a single vector variable (pVec1) is processed in a single pipeline execution. That is, only a single 5-stage pipeline is performed for the vector variable pVec1.

In the loop body execution process (S350), the pointer vector operation is also performed in a single pipeline execution for the vector variable pVec1. Unlike the conventional approach (FIG. 8) where the pipeline was individually performed for each pointer, in the present disclosure, since a plurality of pointer operations are simultaneously processed with a single vector operation instruction, the operations are completed within a constant number of execution cycles regardless of the number of pointers.

Specifically, in the pointer vector operation process, the vector operation unit 122 performs a vector addition operation that performs addition operations in parallel on corresponding elements between the plurality of address values stored in the vector register 121 and the plurality of offset values stored in the vector offset variable. Through this, the address values of all pointers are updated with a single vector instruction at each loop iteration.

Furthermore, in the conventional individual pointer approach, each pointer was independently incremented and memory access was performed irregularly, but in the pointer vectorization approach, all elements within the vector register can systematically access memory through different offsets. After the pointer vector operation process, the processor 120 can read data in parallel from the memory locations pointed to by each address using a vector load instruction with the updated address values stored in the vector register 121. Through this, various pointer operations such as data load, data store, pointer increment, and address calculation can be performed in a vectorized form.

Comparing FIG. 8 and FIG. 9, in the conventional approach, the number of instruction executions increases in proportion to the number of pointers, whereas in the pointer vectorization approach of the present disclosure, since a plurality of pointers are processed with a single instruction through vector operations in the vectorization (S320) and loop body (S350) stages, the number of instruction executions is significantly reduced and the SIMD computational resources of the CPU can be efficiently utilized.

Table 1 shows simulation results comparing the performance of conventional loop operations and loop operations with pointer vectorization applied. To comparatively evaluate each approach, simulations were performed with the number of pointers set to 2, 4, and 8, and the loop repeated from 10 to 100,000 times. Table 1 shows the execution cycle reduction rate derived by comparing the total execution cycles for each case.

The conventional loop operation procedure proceeds in the order of “pointer setup→loop variable initialization→loop condition check→body execution→pointer operation→loop variable update,” with the basic execution cycle for each procedure set to 1. In particular, it was assumed that the execution cycles increase in proportion to the number of pointers used in the pointer setup and pointer operation stages. On the other hand, the loop operation procedure with pointer vectorization applied has the same execution flow, but since the pointer operations are performed in a vectorized manner, they are processed in a single execution cycle regardless of the number of pointers.

TABLE 1

| | 10 | 100 | 1000 | 10000 | 100000 |
|---|---|---|---|---|---|
| | loops | loops | loops | loops | loops |
| 2 pointer | 12.16% | 14.06% | 14.26% | 14.28% | 14.29% |
| 4 pointer | 25.00% | 27.03% | 27.25% | 27.27% | 27.27% |
| 8 pointer | 34.50% | 36.60% | 36.82% | 36.84% | 36.84% |

Referring to Table 1, it can be seen that the performance improvement effect of the approach with the pointer vectorization technique applied becomes greater as the number of pointers increases. For example, when using 8 pointers and repeating the loop 100,000 times, an execution cycle reduction rate of approximately 36.84% was achieved. While only relative reduction rates were considered here, when comparing absolute execution cycle counts, the pointer vectorization approach can provide much more effective performance improvement.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

Meanwhile, the embodiments of the present invention disclosed in the specification and drawings are merely presented to provide specific examples for ease of understanding and are not intended to limit the scope of the present invention. It will be apparent to those of ordinary skill in the art to which the present invention pertains that other modified examples based on the technical idea of the present invention may be practiced in addition to the embodiments disclosed herein.

The scope of protection of the present embodiment should be interpreted by the following claims, and all technical ideas within the equivalent scope thereof should be interpreted as being included in the scope of rights of the present embodiment.

What is claimed is:

1. A method performed by one or more computers for performing a loop operation including pointer operations on a plurality of pointers, the method comprising:
a pointer vectorization process of vectorizing the plurality of pointers by storing an address value pointed to by each of the plurality of pointers as an individual element of a vector register of a processor to generate a vector variable, wherein each element of the vector variable represents a memory address of an individual pointer; and
a pointer vector operation process of updating addresses of the plurality of pointers stored in the vector register in parallel through a vector operation using a preset vector offset variable during execution of a loop body.

2. The method of claim 1, wherein the vector register is a SIMD (Single Instruction Multiple Data) register or a CPU register supporting vector operations.

3. The method of claim 1, wherein the pointer vectorization process comprises:
loading an initial address value of each of the plurality of pointers and sequentially storing them at consecutive element positions of the vector register before entering the loop.

4. The method of claim 1, wherein the vector offset variable is configured in a vector form storing different offset values corresponding to sizes of data types referenced by respective pointers as individual elements.

5. The method of claim 1, wherein the pointer vectorization process comprises:
generating a vector offset variable for defining a relative memory position change of memory address values pointed to by the plurality of pointers in the pointer vector operation process.

6. The method of claim 1, wherein the pointer vector operation process comprises:
computing, using a vector addition instruction, the address values stored in the vector register and the offset values stored in the vector offset variable to generate updated address values.

7. The method of claim 1, further comprising, after the pointer vector operation process:
reading data in parallel from memory locations pointed to by each address using a vector load instruction with the updated address values of the plurality of pointers stored in the vector register.

8. An apparatus for performing a loop operation including pointer operations on a plurality of pointers, the apparatus comprising:
a memory storing instructions; and
a processor including a vector register,
wherein the processor is configured to, by executing the instructions:
perform pointer vectorization of vectorizing the plurality of pointers by storing an address value pointed to by each of the plurality of pointers as an individual element of the vector register to generate a vector variable, wherein each element of the vector variable represents a memory address of an individual pointer; and
perform a pointer vector operation of updating addresses of the plurality of pointers stored in the vector register in parallel through a vector operation using a preset vector offset variable during execution of a loop body.

9. The apparatus of claim 8, wherein the vector register is a SIMD (Single Instruction Multiple Data) register or a CPU register supporting vector operations.

10. The apparatus of claim 8, wherein the processor is configured to, in performing the pointer vectorization:
load an initial address value of each of the plurality of pointers and sequentially store them at consecutive element positions of the vector register before entering the loop.

11. The apparatus of claim 8, wherein the vector offset variable is configured in a vector form storing different offset values corresponding to sizes of data types referenced by respective pointers as individual elements.

12. The apparatus of claim 8, wherein the processor is configured to, in performing the pointer vectorization:
generate a vector offset variable for defining a relative memory position change of memory address values pointed to by the plurality of pointers in the pointer vector operation.

13. The apparatus of claim 8, wherein the processor is configured to, in performing the pointer vector operation:
compute the address values stored in the vector register and the offset values stored in the vector offset variable with a single vector addition instruction to generate updated address values.

14. The apparatus of claim 8, wherein the processor is further configured to, after the pointer vector operation:
read data in parallel from memory locations pointed to by each address using a vector load instruction with the updated address values of the plurality of pointers stored in the vector register.
